(19) United States
(12) Patent Application Publication
(10) Pub. No.: US 2016/0125530 A1
(43) Pub. Date: May 5, 2016

(54) SELF LIQUIDATING LOAN FOR BANKS

(71) Applicants: Josiah David, Vernon, NJ (US); Denis Joachim, Mandeville, LA (US)

(72) Inventors: Josiah David, Vernon, NJ (US); Denis Joachim, Mandeville, LA (US)

(21) Appl. No.: 14/923,439

(22) Filed: Oct. 27, 2015

Related U.S. Application Data
(60) Provisional application No. 62/072,376, filed on Oct. 29, 2014.

(51) Int. Cl. G06Q 40/02

(52) U.S. Cl. CPC G06Q 40/025

(57) ABSTRACT

The method of the preferred embodiments provides a loan made to an individual into an account at the lending bank, under contract that the owner of the deposit account will leave the principal amount in the account at the lending bank unless authorized to do otherwise by the lending bank. The money of the principal amount of the loan is transferred and stored either on the non-transitory computer readable medium of the servers used by the lending bank institution, or in physical monetary or value holding instruments held by the lending bank. The principal amount does not leave the possession or accounts of the lending bank. The loan is additionally required under contract to have interest paid by the owner of the deposit account for the loan term. The method is intended to allow the owner of the deposit account to report greater liquidity in the name of the owner of the deposit account.

### CROSS-REFERENCE TO RELATED APPLICATIONS

This application is a non-provisional continuation of U.S. Provisional Patent Application Ser. No. 62/072,376 filed 29 Oct. 2014 and entitled “A SAFE SELF LIQUIDATING LOAN FOR BANKS AND A 105 MEDICAL REIMBURSMENT ACCOUNT FOR THE BORROWER”, the priority of which is claimed by this application, and the entire contents and substance of which are hereby incorporated in total by reference.

### BRIEF DESCRIPTION OF THE FIGURES

FIG. 1 is a schematic representation of the method of the first preferred embodiments, showing the loan amount originating from the lending institution, transferred via one or more of the bank servers and physical instruments of value, and placed into a deposit account linked to the deposit account owner in the lending bank.

FIG. 2 is a schematic representation of the method of the first preferred embodiments, wherein the deposit account owner pays interest into the deposit account.

FIG. 3a is a schematic representation of the method of the first preferred embodiments, wherein one or more of the deposit account owner, the employees of the deposit account owner, and the associates of the deposit account owner, are enabled to enroll in one or more of a medical reimbursement program, and a reverse insurance program.

FIG. 3b is a schematic representation of the method of the first preferred embodiments, wherein one or more of the deposit account owner, the employees of the deposit account owner, and the associates of the deposit account owner, are enabled to enroll in one or more of a government program, an insurance program, a medical program.

FIG. 3c is a schematic representation of the method of the first preferred embodiments, wherein one or more of the deposit account owner, the employees of the deposit account owner, and the associates of the deposit account owner, are enabled to enroll in the IRS code 105 medical reimbursement program.

FIG. 4 is a schematic representation of the method of the first preferred embodiments, showing the liquidity maintained by the bank as a result of the program.

FIG. 5 is a schematic representation of the method of the first preferred embodiments, showing that the deposit account does not pay interest to the deposit account owner or into the deposit account.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

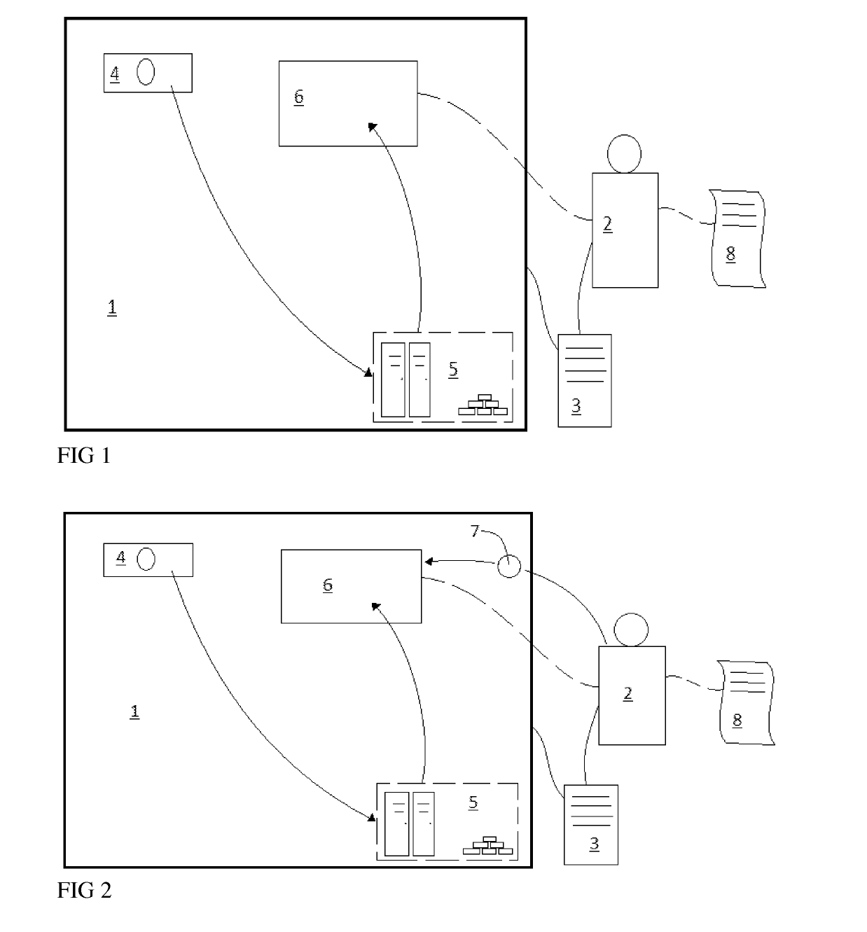

As shown in FIG. 1, the method of the preferred embodiments provides a loan made to an individual into an account at the lending bank 1, under contract 3 that the owner of the deposit account 6 will leave the principal amount 4 in the account at the lending bank 1 unless authorized to do otherwise by the lending bank 1. The money of the principal amount 4 of the loan is transferred and stored either on the non-transitory computer readable medium of the servers 5 used by the lending bank 1 institution, or in physical monetary or value holding instruments 5 held by the lending bank 1. The principal amount 4 does not leave the possession or accounts of the lending bank 1 for any significant amount of time before being placed into the deposit account 6, and preferably does not leave the lending bank 1. The loan is additionally required under contract 3 to have interest 7 paid by the owner of the deposit account 6 for the loan term. The method is intended to allow the owner of the deposit account 6 to report greater liquidity 8 in the name of the owner of the deposit account 6.

As shown in FIG. 1, the principal amount 4 of the loan is retained in the lending bank 1.

This allows the bank to retain liquidity 12 in the amount of most of the principal amount 4. The loan is governed by a third party, in the form of a contract 3, organization or person. The third party or contract 3 prevents the owner from accessing the funds in the deposit account 6 without consent of the lending bank 1. Preferably there is a contract 3 with or without a third party conducting oversight. The contract 3 preferably stipulates any circumstance under which the funds in the deposit account 6 may be accessed by the deposit account owner 2. The deposit account owner 2 may be one or more of A) an individual and B) an organization. As shown in FIG. 2, preferably the contract 3 also requires that the account will grow beyond the principal amount 4, due at least to the owner of the deposit account 6 depositing interest charges 7 into the deposit account 6. At the end of the loan period, preferably 1 year, the lending bank 1 can choose to remove all funds and interest 7 from the deposit account 6, or the lending bank 1 can choose to renew the loan for another loan period and only remove the interest 7 amount. The self liquidating loan may, however, be regulated, controlled, or governed by any suitable means and by any suitable party. The loan period may involve any suitable amount of time, and may include any suitable milestones, withdrawals, or deposits. The owner of the deposit account 6 may be any suitable organization, individual, or manager of any suitable program.

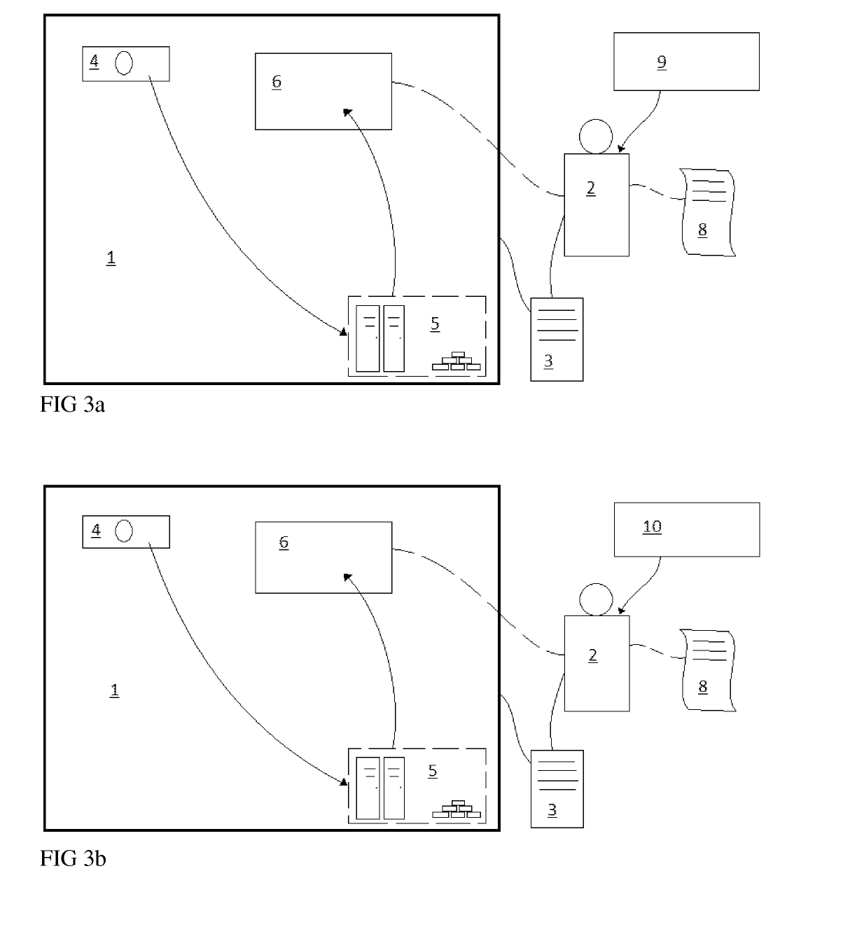

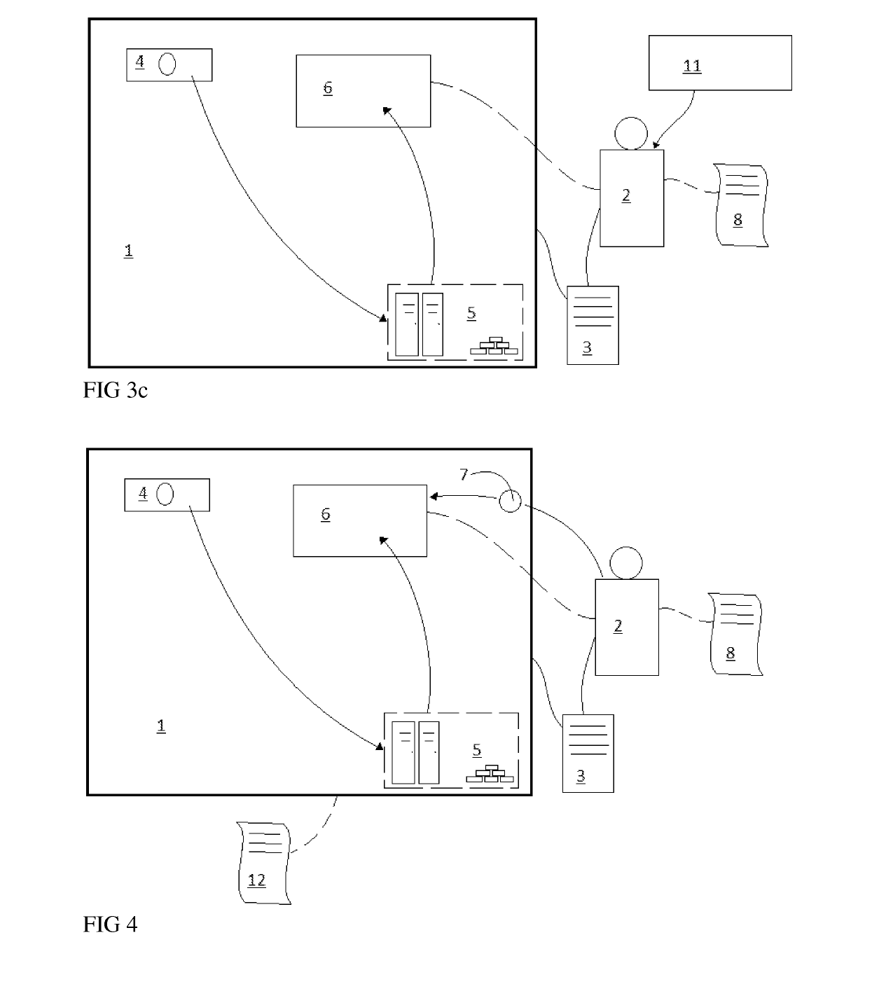

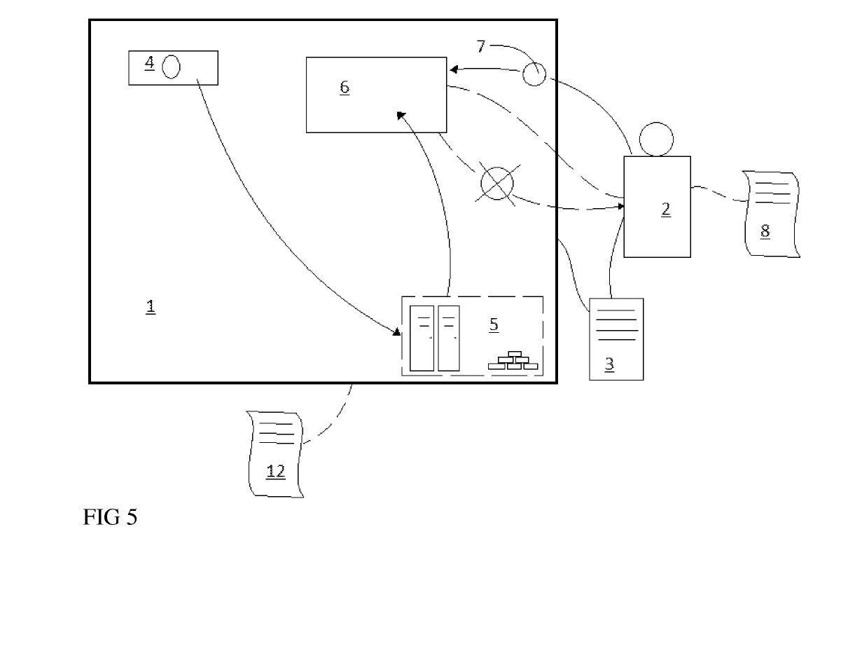

As shown in FIG. 1, the self liquidating loan provides an amount of funds in a deposit account 6 under the name of the deposit account owner 2, which allows the deposit account owner 2 to report liquidity 8 in the amount of the deposit account 6 in addition to any other form of liquidity available to the owner of the deposit account 6. This allows the deposit account owner 2 to report greater liquidity 8, which can enable the qualification for programs and opportunities of one or more of: the deposit account owner 2, employees of the deposit account owner 2, or associates of the deposit account owner 2. As shown in FIGS. 3a-3c, the deposit account owner 2, or the deposit account owner's 2 employees or associates, may be qualified for programs including medical insurance programs 9, medical reimbursement programs 9, reverse insurance programs 9, government aide programs 10, government loan programs 10, government assistance programs 10, and government reimbursement programs 10. The greater liquidity 8 reported by the owner of the deposit account 6 may, however, be used by the deposit account owner 2 for any suitable purposes. As shown in FIG. 3c, the medical reimbursement programs may include the IRS code 105 program 11. Medical reimbursement programs 9 may, however, include any suitable programs. The benefits of the programs the deposit account owner 2 is qualified for are preferably of greater value than the interest 7 paid on the principal amount 4 under the contract 3 governing the self liquidating loan with the lending bank 1. However, there may be any suitable benefits or motivations for the deposit account owner 2 to enter into the agreement.

As shown in FIG. 5, the deposit account 6 preferably does not pay or build interest 7 on the deposited amount, as the funds in the deposit account 6 are loaned on interest 7 and are intended to increase the reported liquidity 8 of the deposit account owner 2.

The self liquidating loan is preferably carried out by the processors on servers 5 held by the lending bank 1, and recorded on the computer readable medium of the servers. These secure servers 5 of the lending bank 1 are used to track and move the funds held by the lending bank 1, and to link the funds to accounts and account owners 2. In a second preferred embodiment, a portion or all of the loan funds and deposit account 6 funds may be held and moved in the form of valuable physical instruments 5, which may include paper money, gold, coins, and other instruments. Preferably the method is inseparable from these physical value holding aspects of the infrastructure of the lending bank 1, and the method of the preferred embodiments is physically represented in funds tied to the physical infrastructure and holding of the lending bank 1. In a preferred embodiment, the lending method is not an abstraction that can be used in any scenario, but is instead a method carried out in the physical holdings and infrastructure of the lending bank 1 and represented by funds backed by real monetary value. In the preferred embodiment and in accordance with the FDIC regulations, these funds are allowed to be withdrawn in physical amounts in accordance with law. The method may, however, be carried out in association with any physical holdings or infrastructure, with any movement and lending of any instruments of value, and in accordance with any set of regulations.

In an alternative embodiment, the deposit account owner 2 may be the manager of the IRS code 105 account. In an alternative embodiment, there may be multiple individual loans and multiple individual borrowers managed as a system of loans and borrowers with access to one or more programs 9, 10, 11 as a result of the reported liquidity 8 of each individual. The manager of the IRS code 105 account may manage the loans and borrowers in accordance with the contract 3 of the loan, and also to satisfy the requirements of the IRS code 105 program 11. In the alternative embodiment, the manager may manage such a system of multiple loans for multiple individuals in association with any suitable program.

The loan amount is preferably collateralized by the deposit account 6, which is preferably not accessible to the deposit account owner 2 under the provisions of the contract 3.

In one embodiment, the employees of the deposit account owner 2, or the individual borrowers managed by the program manager, will have an amount drawn from their paycheck on payday and deposited into the deposit account 6. Preferably this amount at least covers the interest 7 of the loan. An amount beyond the interest 7 due on the loan may also be taken from the paycheck of the employees of the deposit account owner 2, or the the individual borrowers managed the by the program manager 2, and this extra amount may be put towards a program the employee or individual is enrolled in. This program 9, 10, 11 may include one or more of a government program, a medical reimbursement program, an insurance program, and the IRS code 105 medical reimbursement program 11.

As a person skilled in the art will recognize from the previous detailed description and from the figures and claims, modifications and changes can be made to the preferred embodiments of the invention without departing from the scope of this invention defined in the following claims.

We claim:

1) A method for a self liquidating loan from a lending bank, wherein the lending bank makes a loan to at least one of A) an individual and B) an organization, wherein the at least one of A) an individual and B) an organization enters into a contract with the bank guaranteeing that the principal amount of the loan will not be moved from the lending bank without consent from the lending bank, wherein the amount of the loan is kept by the lending bank in at least one of 1) computer readable medium on servers kept by the lending bank institution for maintaining account balances, and 2) physical instruments of monetary value.

2) The self liquidating loan of claim 1, wherein the loan amount is deposited into an account at the lending bank without removing the principal amount of the loan from the lending bank.

3) The self liquidating loan of claim 2, wherein the contract guarantees that the deposit account will grow beyond the principal amount over the term of the loan.

4) The self liquidating loan of claim 3, wherein the at least one of A) an individual and B) an organization pays a premium interest rate, wherein the interest is added to the deposit account over the term of the loan.

5) The self liquidating loan of claim 4, wherein at the end of the loan term the lending bank has sole discretion to remove the principal loan amount and interest amount and end the loan agreement.

6) The self liquidating loan of claim 4, wherein the contract specifies designated circumstances under which the recipient of the loan is permitted to remove any amount from the deposit account.

7) The self liquidating loan of claim 6, wherein the owner of the deposit account can report greater financial liquidity due to the ownership of the deposit account.

8) The self liquidating loan of claim 7, wherein the greater financial liquidity reported by the owner of the deposit account allows at least one of 1) the owner of the deposit account, and 2) employees of the owner of the deposit account into at least one of A) a medical reimbursement program, and B) a reverse insurance program.

9) The self liquidating loan of claim 7, wherein the greater financial liquidity reported by the owner of the deposit account allows at least one of 1) the owner of the deposit account, and 2) employees of the owner of the deposit account into at least one of A) a government program, B) an insurance program, C) a medical program.

10) The self liquidating loan of claim 4, wherein the lending bank maintains the liquidity represented by the principal amount because the deposit account is in the lending bank.

11) The self liquidating loan of claim 6, wherein the deposit account does not pay interest.

12) The self liquidating loan of claim 8, wherein the medical reimbursement program is an IRS code 105 reimbursement program.

13) The self liquidating loan of claim 4, wherein the loan is carried out by at least one of 1) the processors of the server computers physically held by the lending bank, and 2) the movement of physical instruments of value in the lending bank.

14) The self liquidating loan of claim 13, wherein at the end of the loan term the lending bank has sole discretion to remove the principal loan amount and interest amount and end the loan agreement.

15) The self liquidating loan of claim 13, wherein the contract specifies designated circumstances under which the recipient of the loan is permitted to remove any amount from the deposit account.

16) The self liquidating loan of claim 15 wherein the owner of the deposit account can report greater financial liquidity due to the ownership of the deposit account.

17) The self liquidating loan of claim 16, wherein the greater financial liquidity reported by the owner of the deposit account allows at least one of 1) the owner of the deposit account, and 2) employees of the owner of the deposit account into at least one of A) a medical reimbursement program, and B) a reverse insurance program.

18) The self liquidating loan of claim 17, wherein the medical reimbursement program is an IRS code 105 reimbursement program.
